(19) United States
(12) Patent Application Publication
(10) Pub. No.: US 2003/0047578 A1
(43) Pub. Date: Mar. 13, 2003

(54) Mountable sport bottle

(76) Inventor: Charles Michael Barnett, Jonesboro, AR (US)

Correspondence Address: Dennis B. Haase, Esq., Post Office Box 3592, Little Rock, AR, 72203, US

(21) Appl. No.: 09/949,555

(22) Filed: Sep. 10, 2001

(51) Int. Cl. B60R 7/00; B60R 11/00

(52) U.S. Cl. 224/562; 224/926; 224/901.8

(57) ABSTRACT

A vehicle, such as a garden tractor, riding mower or golf cart, with sport bottles, having fluid refreshment therein, removably adhered thereto in which the various body parts of the vehicle are disposed in different planes and the sport bottles are formed with attachment devices which are removably adherent to the various body parts to support the sport bottle, irrespective of the plane of the body part to which it is adhered.

The present invention relates to closed, portable, sport type bottles for selective dispensing of liquids and, more particularly, to such bottles which are capable of being positioned on a metal surface when not in its dispensing mode.

### BACKGROUND OF THE INVENTION

1. Field of the Invention

Health advocates have uniformly been proponents of hydration as a means of maintaining one's health and vigor. For the very active, the consumption of water and other fluids is a necessity, particularly in warmer climes.

The venerable water bucket was the staple at sporting events for years and is still a standby in the form of cups of liquid immediately available for replenishment of fluid needs of participants.

While cups are convenient for providing measured amounts of fluid, they are also susceptible to contamination by all manner of airborne foreign matter, including bugs and the like.

Moreover, cups in particular, but other vessels also, are typically shaped to be stackable in order that they can be nested with one another for storage and transportation. In order to be stackable, or nestable, as the case may be, the base of the vessel is often of lesser diameter than the upper dimension. As a result, such vessels become less stable when they are filled with a liquid and may be tipped, spilling its contents, more readily than is desirable in situations where there is activity in the immediate area.

In order to obviate many of the perceived deficiencies an industry has grown up around the manufacture of water bottles. Additionally, since many are intent on carrying bottles around with them, a satellite industry has sprung up to produce devices to carry such bottles, most such devices being in the form of a sling, or jacket, into which the bottle is received for transportation.

There are activities, however, where the capacity to position and support a sport bottle itself, sans accessory, is a distinct advantage, and it is to this segment of the consuming public that the present invention has significant utility.

2. Overview of the Prior Art

The market is replete with all sorts of bottle carriers for those who wish to carry water while hiking, biking, running, surf boarding and less rigorous activities. For those who want a supply of fluid within easy reach, but are more sedentary, the market provides an array of holders with hooks to fit in louvers of the ventilation system of a car, cups to hold cups or bottles, and various other holders, among them the cup holder of Morgan U.S. Pat. No. 5,873,486, which is little more than an insulated receptacle open at the top for receiving, and holding, a cup. Morgan discusses a number of ways that the cup holder can be supported in a car.

Henry U.S. Pat. No. 2,217,514 discloses a cup holder and, additionally, plates, beakers, bowls, ink wells, bottles and the like with a magnet in the base to hold it to a metal surface.

Faudi U.S. Pat. No. 5,456,436 and Rogers U.S. Pat. No. 6,193,202 BI both depict holders for drinking vessels, the holders being equipped, such as by a magnet, to secure the holder to a metallic surface.

Finally, Wicker U.S. Pat. No. 6,206,223 BI provides a can cooler receptacle, with no particular way of mounting it to any surface other than perhaps by friction, the base being of a foam material.

None of these patented structures are able to serve the purpose for which the present invention was developed.

### SUMMARY OF THE INVENTION

The present invention is directed to that segment of society which uses, on a relatively regular basis, a riding mower or lawn tractor, golf cart, or an all terrain vehicle, as a personal tool, or a commercial vehicle as part of their vocation. It is intended to, and does, provide to the user of such vehicles, a means of keeping a fluid source close at hand during use, without resort to some sort of cage, or other holder accessory.

Accordingly, it is a principal objective of the present invention to provide, for use by those who use a personal or commercial vehicle as part of their avocation or vocation, a sport bottle which will removably attach, at any number of convenient locations on such a vehicle, as a ready supply of fluid to be ingested by the user at his or her need or whim.

It is another objective of the present invention to provide a reusable sport bottle containing an ingestable fluid which is removably positioned against any surface for ready access by a user.

An objective related to the foregoing, is to provide a reusable sport bottle which will adhere to a metal surface and support the bottle and its contents to such surface even as the surface is jostled or otherwise caused to assume unfavorable attitudes.

More specifically, it is an objective of the present invention to provide the operator of an open vehicle, such as a garden tractor or ATV, with a sport bottle which can be instantly adhered to a suitable portion of the vehicle within arms reach and to be able to remove the bottle for use at the instance of the operator and, thereafter, re adhered without distracting the operator from his or her effort.

The foregoing, as well as other objects and advantages of the present invention, will become apparent from a reading of the Detailed Description of a Preferred Embodiment, when taken in conjunction with the sheet of accompanying drawing wherein:

### DESCRIPTION OF THE FIGURES OF THE DRAWING

FIG. 1 is a pictorial representation of an open air vehicle, such as a garden tractor, golf cart, or the like, illustrating a sport bottle as it would removably attach to various surfaces of such vehicle, which surfaces are in various different planes;

FIG. 2 is a perspective view of a sport bottle of the present invention, illustrating a preferred positioning of attachment devices to accomplish the purposes of the invention; and

FIG. 3 is a side elevation of the lower portion of the sport bottle of FIG. 2, fragmented and sectioned to further clarify the positioning of the attachment devices.

### PREFERRED EMBODIMENT OF THE PRESENT INVENTION

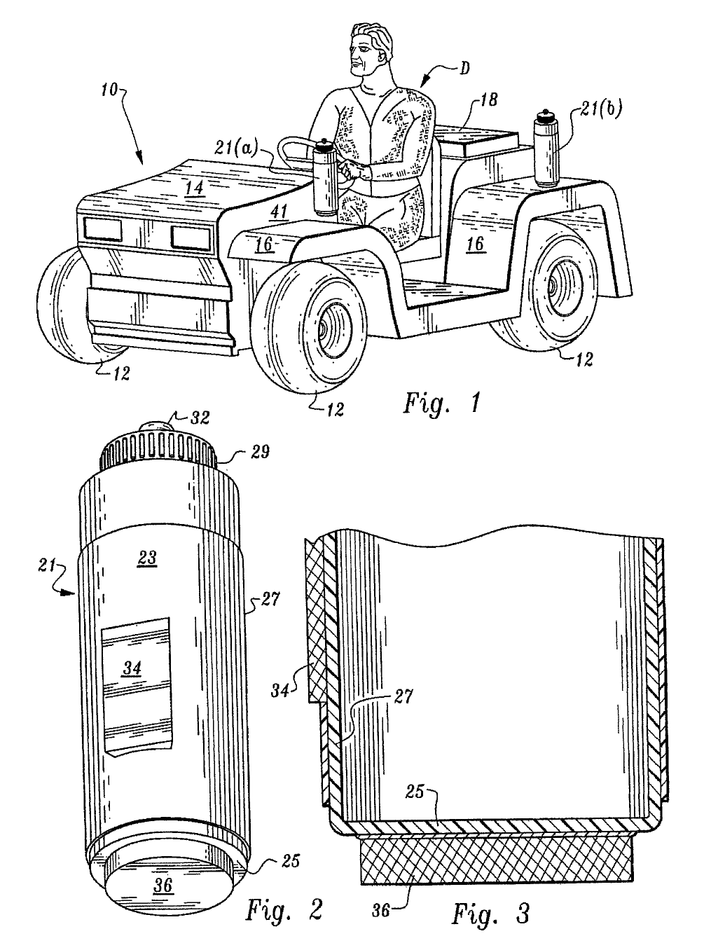

With reference now to the drawing, and initially to FIG. 1, a vehicle 10 is illustrated as exemplary of the type of vehicle, equipped as taught by the present invention, in which it has particular utility.

It will be appreciated that while the illustrated vehicle, which is intended to represent, pictorially, a garden tractor, golf cart or ATV, sometimes referred to as an open air vehicle, placing a covering over the cockpit of the vehicle would not diminish the value of the present invention. Moreover, although the vehicle is shown as supported for movement on four wheels, 12, it may also have three, and even as many as six, and with three axles.

The illustrated vehicle 10 is shown as having several body parts, or elements, such as a forward hood 14, and fenders 16. A rear deck 18 projects behind the driver D.

Removably adhered to the vehicle 10, in accordance with the teachings of the invention, are sport bottles 21(a) and 21(b). The sport bottles 21(a) and 21(b) are substantially identical and the difference in designation is intended to represent positioning rather than structural variations. The sport bottle may be referred to herein by the numeral 21 where the position of the bottle is not relevant to the description.

The sport bottle 21 is formed with a generally cylindrical body 23, having a generally flat, or planer, base member 25, typically formed integrally with the cylindrical body at one end thereof, which provides a planer outside wall 27. An opening at the opposite end of the cylindrical body (not specifically illustrated) is capped by a closure device 29.

The closure device preferably includes a push/pull spout 32, also sometimes referred to as a pop top. Such a closure device is significant in that it protects the fluid in the sport bottle from contamination with foreign matter, e.g., dust and bugs, which is indigenous to the environment in which vehicles such as vehicle 10 often operate, while permitting the driver to open and close the sport bottle 21 while operating the vehicle without distraction from the task at hand.

In order that the sport bottle 21 be capable of being removably adhered to various surfaces of the vehicle 10, the sport bottle is equipped with attachment devices 34 and 36. While the precise positioning of the attachment devices may be considered a matter of design, it is within the scope of the invention that one such device, 34 be secured to the planer side wall 27 of the sport bottle 21, while the attachment device 36 is affixed to the bottom, or base, 25 of the bottle. By selecting these positions, which lie in transverse planes, the sport bottle 21 is capable of being removably adhered to varying surfaces of the vehicle 10.

It is within the contemplation of the invention that the attachment devices 34 and 36 be in the form of magnets. While the attachment device 34 is shown as a strip and attachment device 36 is shown as a disk, it is within the contemplation of the invention that a magnetic ribbon, by way of example, could encircle the entire bottle, and other forms might also be used.

Magnets are preferred in that many of the vehicles which could use the present invention advantageously have ferro metallic surfaces to which a magnet would adhere with sufficient force to support the sport bottle 21, full of fluid, in a variety of attitudes without causing the bottle to drop or become dislodged.

In the case of some golf carts, which have fiber glass surfaces, a strong velcro attachment would serve a utilitarian purpose.

Thus, it will be seen in FIG. 1 that a sport bottle 21(a) is readily adhered to a substantially vertical side panel within easy reach of the driver D, and another such bottle 21(b) is equally accessible when adhered to a rear portion of the fender 16. It will now be apparent to one skilled in the art that several other mounting locations are available, thereby graphically illustrating the versatility, as well as the utility, of the invention.

Having thus described a preferred embodiment of the present invention, what is claimed is:

1. A sport bottle having a cylindrical body with a base at one end thereof, and an opening at the opposite end;
a closure about said open end, said closure having a push/pull spout therein;
a first attachment device, said first attachment device being disposed on said cylindrical body;
a second attachment device, said second attachment device being disposed on said base;
said attachment devices adapted to adhere to a planer surface to removably attach said sport bottle thereto.

2. The sport bottle of claim 1, wherein said attachment devices include magnets.

3. The sport bottle of claim 1, wherein said first attachment device comprises a strip of magnetic material, said strip of magnetic material circumscribing said cylindrical body.

4. The sport bottle of claim 1, wherein said attachment devices comprise velcro strips.

5. The sport bottle of claim 3, wherein said first attachment device comprises a velcro strip, said velcro strip circumscribing said cylindrical body.

6. On a vehicle in which said vehicle is supported for movement on wheels, and is provided body parts including a front hood, a rear, deck, fenders and side panels, at least some of which are in transverse planes;
at least one sport bottle removably adhered to one of said body parts; said sport bottle having a cylindrical body with a base at one end thereof, and an opening at the opposite end;
a closure about said open end, said closure having a push/pull spout therein;
a first attachment device, said first attachment device being disposed on said cylindrical body;
a second attachment device, said second attachment device being disposed on said base;
said attachment devices adapted to adhere to a planer surface to removably attach said sport bottle thereto.

7. The vehicle of claim 6, wherein said attachment devices include magnets.

8. The vehicle of claim 6, wherein said first attachment device comprises a strip of magnetic material, said strip of magnetic material circumscribing said cylindrical body.

9. The vehicle of claim 6, wherein said attachment devices comprise velcro strips.

10. The vehicle of claim 6, wherein said sport bottle is removable adhered to any of said body parts.

11. The vehicle of claim 6, wherein said vehicle is provided with multiple sport bottles removably secured to various body parts.
